(19) United States
(12) Patent Application Publication
(10) Pub. No.: US 2025/0230767 A1
(43) Pub. Date: Jul. 17, 2025

(54) TWO-STROKE ENGINE FOR A VEHICLE

(71) Applicant: BRP-ROTAX GMBH & CO. KG, Gunskirchen (AT)

(72) Inventor: Roland ENNSMANN, Gunskirchen (AT)

(21) Appl. No.: 19/019,809

(22) Filed: Jan. 14, 2025

Related U.S. Application Data
(60) Provisional application No. 63/621,318, filed on Jan. 16, 2024.

(51) Int. Cl. F02B 75/02; F01M 11/00

(52) U.S. Cl. CPC F02B 75/02; F01M 11/00; F02B 2075/025

(57) ABSTRACT

A two-stroke engine assembly includes an engine including an engine block; at least one cylinder formed by the engine block, a cylinder volume being defined by the at least one cylinder; a crankshaft disposed in the engine block; at least one piston disposed in the at least one cylinder; and a protrusion extending into the cylinder volume, the protrusion defining a lubrication groove therein, the lubrication groove being disposed between the crankshaft and the at least one piston; and a lubrication system providing oil to the engine, the lubrication groove being shaped and arranged to collect oil droplets pushed by air toward the at least one piston during operation and to redirect the oil droplets to at least one pre-determined location in the at least one cylinder.

### CROSS-REFERENCE

The present application claims priority to U.S. Provisional Patent Application No. 63/621,318, entitled “Two-Stroke Engine for a Vehicle”, filed Jan. 16, 2024, the entirety of which is incorporated by reference herein.

### FIELD OF TECHNOLOGY

The present disclosure describes a two-stroke engine for a recreational vehicle.

### BACKGROUND

Two-stroke engines are often used in recreational vehicles, such as snowmobiles and watercraft with outboard marine engines. In these engines, the lubricating oil is permitted to mix with the fuel and thus is at least partially consumed with the fuel during combustion. In some cases, the oil is mixed directly with the fuel; in other cases two-stroke engines use electric oil pumps for lubrication, however at significantly lower precision, oil pressure, and flow rates compared to four-stroke engines.

Lubricating oil is therefore not generally targeted at lubrication points as effectively as in four-stroke engines. As oil spreads through the engine, for instance by being splashed towards housing or duct walls by moving parts, oil droplets stick to the wall and are eventually combusted. To improve lubrication, additional oil could be added to the engine in some cases. In order to reduce emissions in two-stroke engines, however, the introduction of oil into the intake air and/or combustion is also generally desired to be reduced as much as possible.

There is thus a desire for a two-stroke engine arrangement addressing at least some of these disadvantages.

### SUMMARY

It is an object of the present technology to ameliorate at least some of the inconveniences present in the prior art.

According to an aspect of the present technology, there is provided a two-stroke engine assembly including an engine including an engine block; at least one cylinder formed by the engine block, a cylinder volume being defined by the at least one cylinder; a crankshaft disposed in the engine block; at least one piston disposed in the at least one cylinder; and a protrusion extending into the cylinder volume, the protrusion defining a lubrication groove therein, the lubrication groove being disposed between the crankshaft and the at least one piston; and a lubrication system providing oil to the engine, the lubrication groove being shaped and arranged to collect oil droplets pushed by air toward the at least one piston during operation and to redirect the oil droplets to at least one pre-determined location in the at least one cylinder.

In some embodiments, the engine block includes a crankcase, and at least one cylinder block connected to the crankcase.

In some embodiments, the protrusion is integrally connected to and formed by the engine block, the protrusion being formed by a cylinder wall defining the at least one cylinder.

In some embodiments, the engine assembly further includes at least one cylinder insert disposed in the at least one cylinder; and the at least one cylinder insert includes the protrusion and the lubrication groove defined in the protrusion.

In some embodiments, the at least one cylinder insert is formed from a hardened plastic.

In some embodiments, the lubrication groove is continuous about a portion of the at least one cylinder; and the lubrication groove is open to the at least one cylinder at the at least one pre-determined location.

In some embodiments, the at least one pre-determined location is an exhaust side of the at least one cylinder.

In some embodiments, the engine assembly further includes at least one cylinder liner disposed in the at least one cylinder; and the lubrication groove is shaped and arranged to direct oil droplets toward at least one portion of the at least one cylinder liner.

In some embodiments, the lubrication groove is shaped and arranged to direct oil droplets toward an exhaust side of the at least one cylinder liner.

In some embodiments, the lubrication groove is sloped at an angle relative to the exhaust side of the at least one cylinder liner.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a rear, left side perspective view of a two-stroke engine according to non-limiting embodiment of the present technology;

FIG. 2 is a top, rear side perspective view of the engine of FIG. 1;

FIG. 3 is a rear elevation view of the engine of FIG. 1;

FIG. 4 is a cross-sectional view of the engine of FIG. 1;

FIG. 5 is another cross-sectional view of the engine of FIG. 1;

FIG. 6 is a top plan view of a lower crankcase and crankshaft of the engine of FIG. 1;

FIG. 7 is a rear, left side perspective view of a crankcase of the engine of FIG. 1;

FIG. 8 is a top, left side perspective view of the crankcase of FIG. 7;

FIG. 9 is a cross-sectional view of the crankcase of FIG. 7;

FIG. 10 is a close-up, cross-sectional view of a portion of an engine insert in the engine of FIG. 1;

FIG. 11 is a close-up, cross-sectional view of another portion of the engine insert in the engine of FIG. 10;

FIG. 12 is a top plan view of the engine insert of FIG. 10, illustrated in isolation;

FIG. 13 is a top, exhaust end perspective view of the engine insert of FIG. 12;

FIG. 14 is a top, side perspective view of the engine insert of FIG. 12;

FIG. 15 is bottom, side perspective view of the engine insert of FIG. 12;

FIG. 16 is a top, left side perspective view of a crankcase according to another non-limiting embodiment of the present technology;

FIG. 17 is a cross-sectional view of the crankcase of FIG. 16; and

FIG. 18 is a cross-sectional, partial view of the crankcase of FIG. 16.

It is noted that the Figures may not be drawn to scale.

### DETAILED DESCRIPTION

The present technology will be described generally with respect to an engine assembly 99, specifically a v-six-cylinder (V6), two-stroke internal combustion engine 100 for a recreational vehicle or outboard motor thereof. However, it is contemplated that some aspects of the present technology may apply to other types of two-stroke internal combustion engine such as, but not limited to, one-cylinder engines, two cylinder inline engines, and differently cylindered v-twin engines. The recreational vehicle implementing the present technology could be selected from a variety of recreational vehicle types, including but not limited to, outboard marine engines for watercraft, snowmobiles, side-by-side vehicles (SSVs), all-terrain vehicles (ATVs), and personal watercraft (PWC).

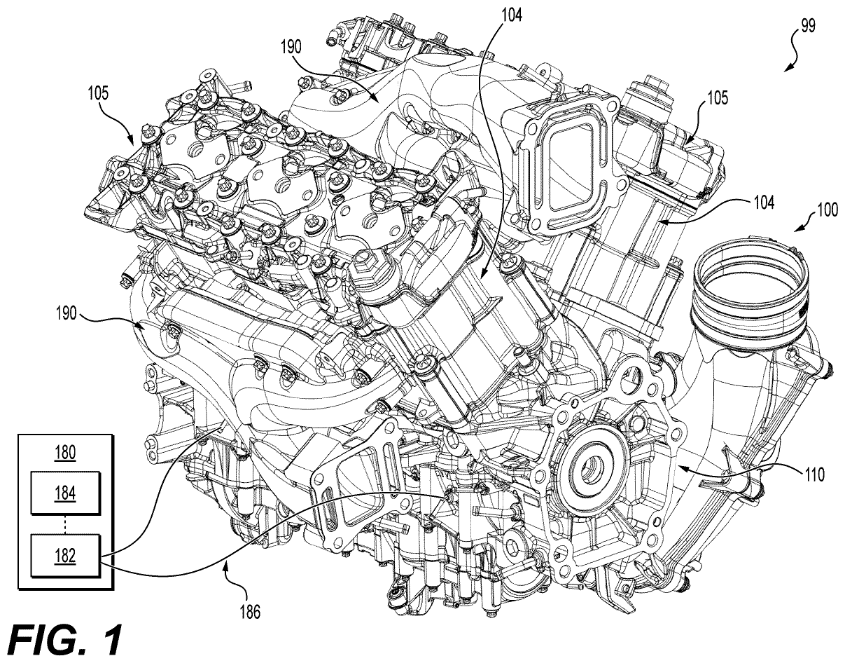

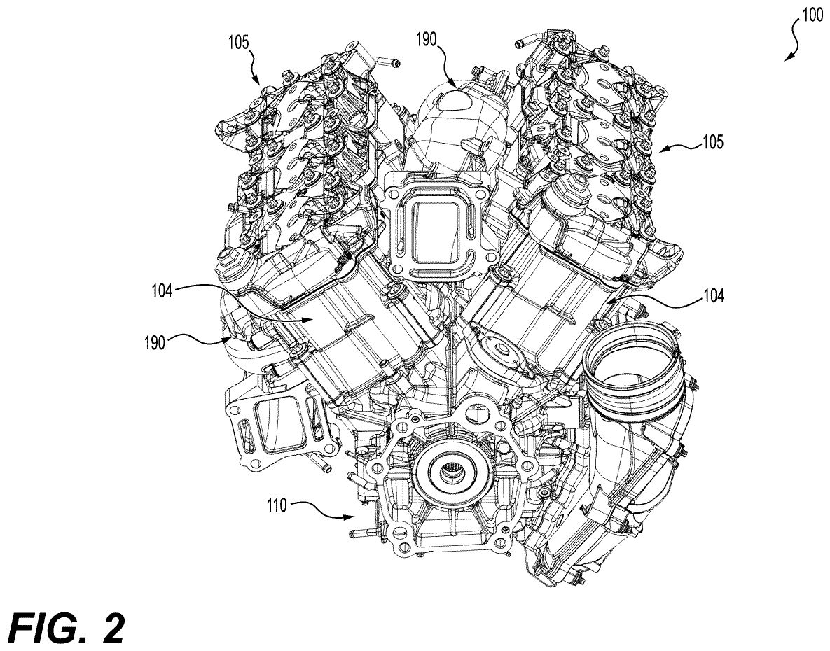

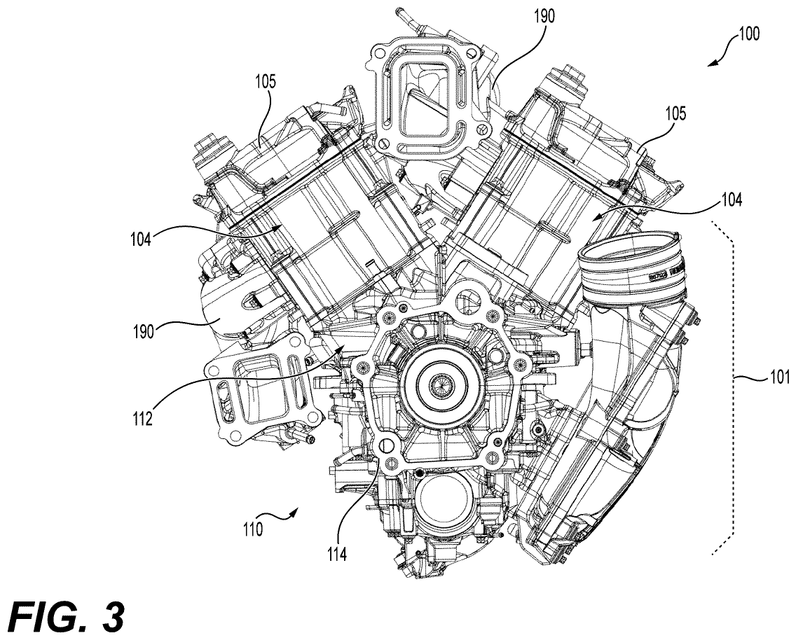

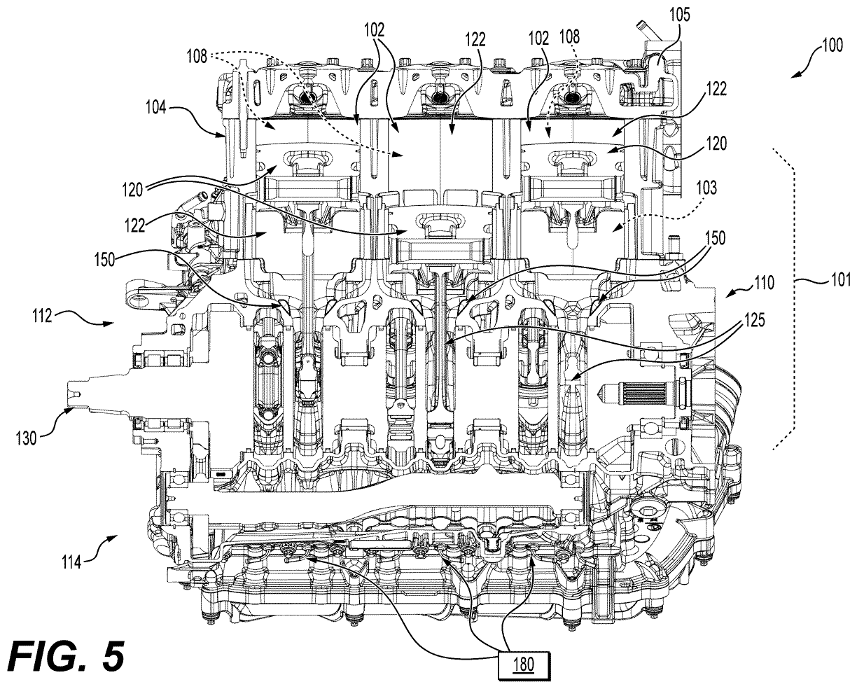

With reference to FIGS. 1 to 4, the engine assembly 99 and the engine 100 for a recreational vehicle or outboard motor is illustrated. The engine 100 in the present embodiment is a two-stroke v-six-cylinder engine having six cylinders 102. The cylinders 102 are contained in and formed by a cylinder block 104. Specifically, three cylinders 102 are defined in each of two cylinder blocks 104 in the present embodiment. The cylinder blocks 104 are each connected to a crankcase 110. The cylinder blocks 104 and the crankcase 110 together form an engine block 101 of the engine 100. In the illustrated embodiment, the crankcase 110 is formed from an upper crankcase 112 and a lower crankcase 114 (see FIG. 5). In some embodiments, it is contemplated that the crankcase 110 could be formed from one integrally connected case. The cylinder blocks 104 are connected to the upper crankcase 112 at an acute angle to each other, in a V-cylinder arrangement. As is noted above, it is contemplated that the present technology could be implemented with an inline cylinder arrangement in some embodiments.

With additional reference to FIG. 5, each cylinder 102 forms a cylinder volume 103 for receiving a piston 120 disposed therein. In the present technology, the engine 100 includes a cylinder liner 122 in each cylinder 102 to define the cylinder volume 103. Each piston 120 can reciprocate within its respective cylinder 102 to change the volume of a combustion chamber 108 associated with the cylinder 102. Each piston 120 is coupled via a connecting rod 125 to a crankshaft 130 received in the crankcase 110.

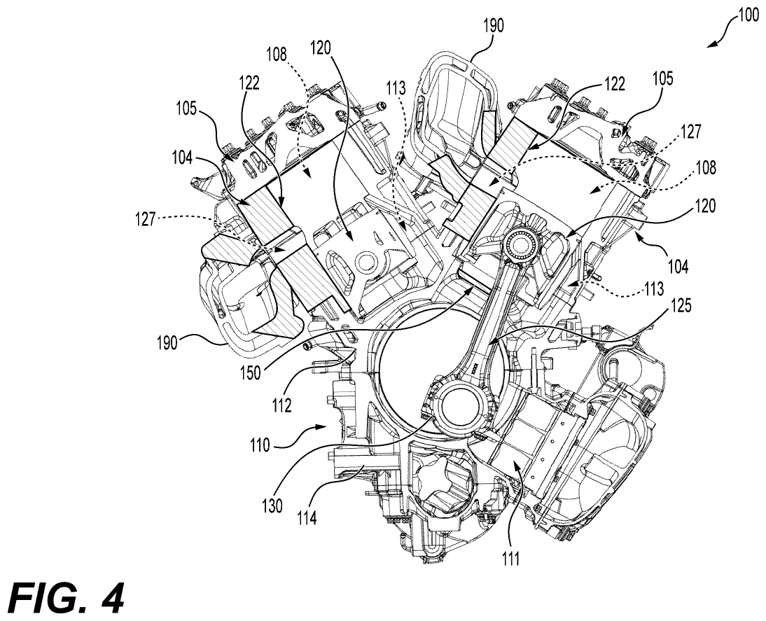

The engine 100 includes a cylinder head 105 connected to each cylinder block 104, opposite the crankcase 110. The combustion chamber 108 is defined between the piston 120 and the cylinder head 105. The engine 100 is arranged with direct fuel injection by fuel injectors (not shown). It is contemplated that in alternative embodiments, the engine 100 could be arranged with port fuel injection to create the air-fuel mixture in the crankcase 110. Intake air is introduced into the crankcase 110 through reed valves 111; see FIG. 4. Each cylinder block 104 and cylinder liner 122 has defined therein an air intake aperture fluidly connecting to the boost port 113 and an exhaust outlet 127 for each cylinder 120 to permit air flow into and exhaust flow out of the corresponding combustion chamber 108. The engine assembly 99 further includes two exhaust manifolds 190 for directing the exhaust away from the cylinder block 104 to an exhaust system (not shown).

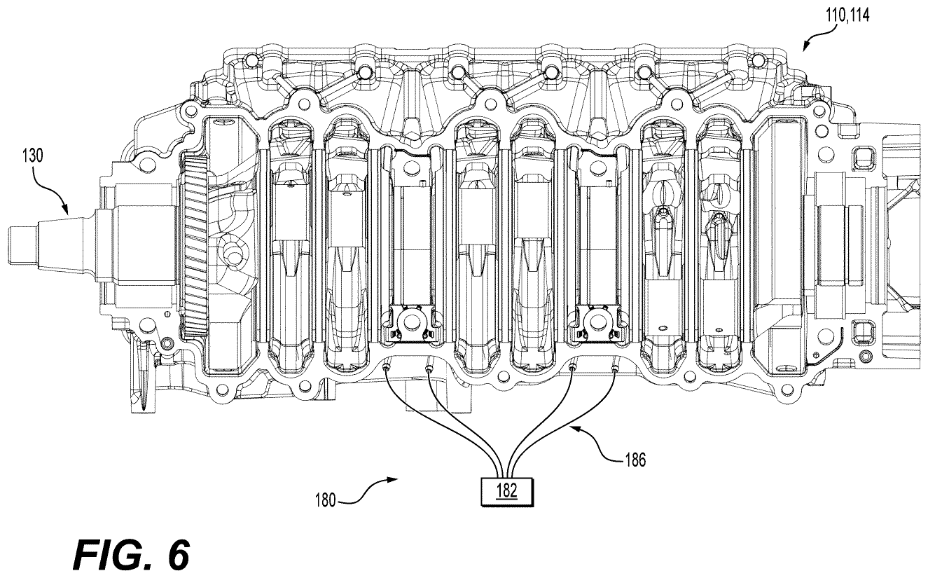

The two-stroke engine assembly 99 further includes a lubrication system 180 operatively connected to the engine 100; see FIG. 1. The lubrication system 180 includes an electric pump 182 (shown schematically) to deliver lubricating oil from a reservoir 184 (shown schematically) to the crankcase 110 of the engine 100. The pump 182 is positioned outside the engine block 101 and supplies oil thereto via tubing or hoses 186 (shown schematically). The engine block 101 has a variety of bearings and passages therein through which oil flows. As is the case for two-stroke engines, the lubricating oil is permitted to flow, spray, and disperse through the interior of the engine 100, from the crankshaft 130 and into the cylinder blocks 104 and the cylinders 102. In the present embodiment, as is illustrated in FIG. 6, oil is first delivered to the crankshaft 130 and is then splashed or disbursed into the cylinder volume 103. Oil may then be pushed upward by movement of air and the piston 120 to enter the combustion chamber 108 and be combusted. In the illustrated embodiment, during upstroke of the piston 120, air with oil droplets is drawn upwards inside the crankcase 110. During downstroke of the piston 120, a portion of the oil flows from the crankcase 110 with the air into the combustion chamber 108 of each cylinder 102, where at least some of the oil may be combusted.

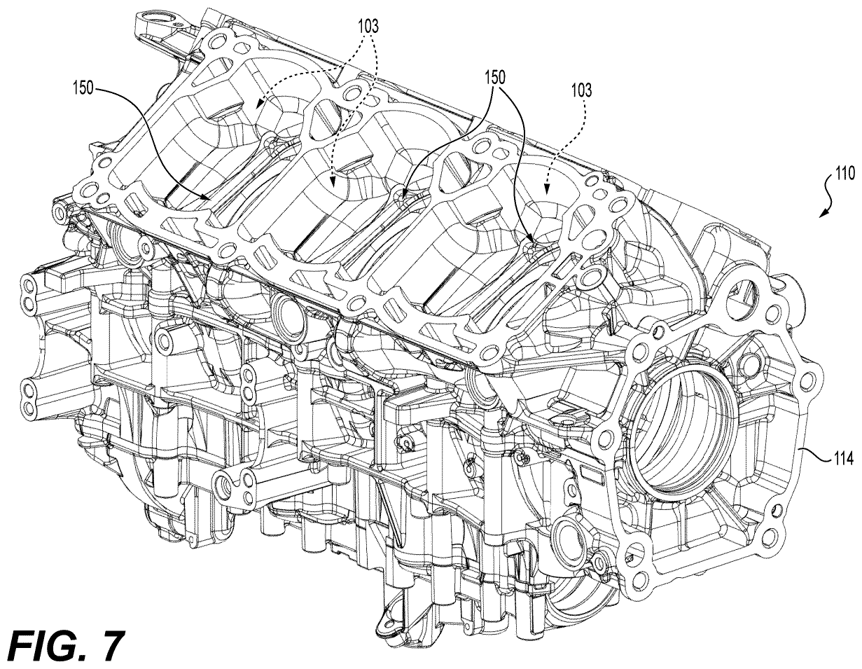

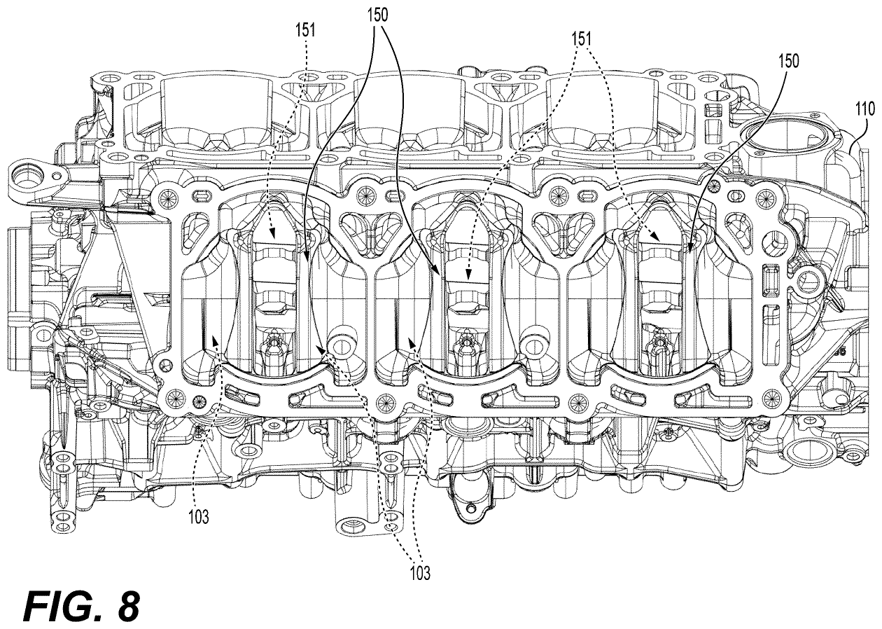

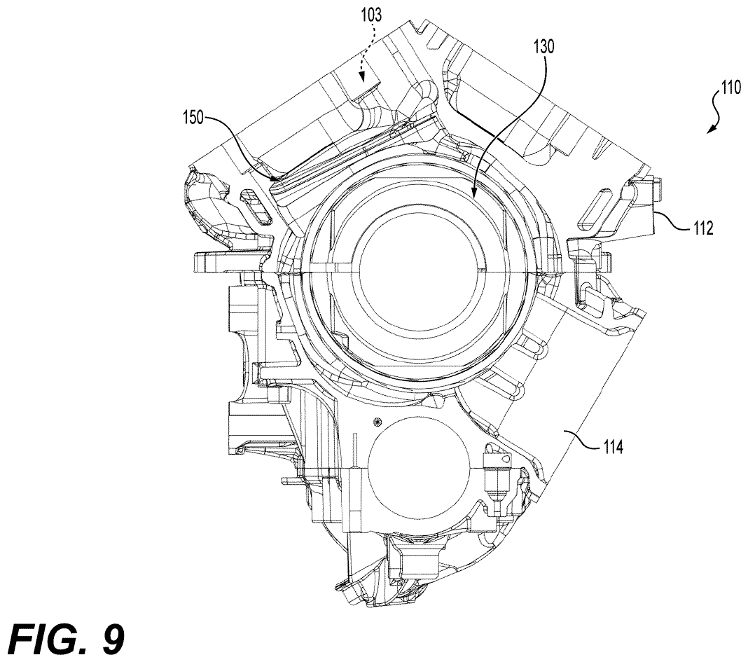

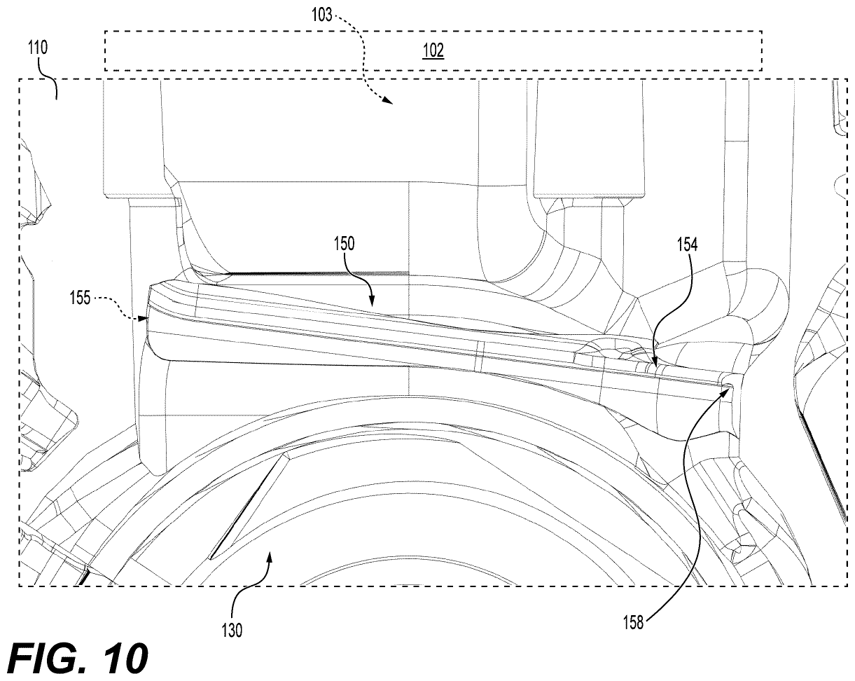

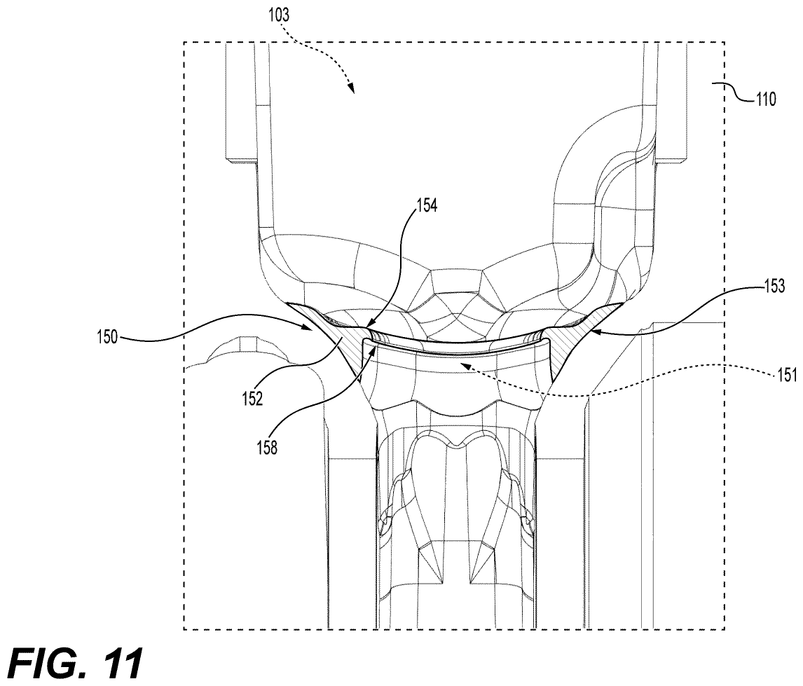

With additional reference to FIGS. 7 to 11, the engine assembly 99 further includes cylinder inserts 150 for aiding in directing the flow of lubricating oil toward the cylinders 102. The cylinder inserts 150 are formed of hardened plastic in the present embodiment, although different materials are contemplated, such as a variety of metals. In the illustrated embodiment, there is one cylinder insert 150 disposed in each cylinder volume 103, between each piston 120 and the crankshaft 130. In other embodiments, it is contemplated that only some or one of the cylinders 102 could be equipped with the cylinder insert 150. In the illustrated embodiment, the cylinder inserts 150 are received in the crankcase 110 above the crankshaft 130, but it is contemplated that the cylinder inserts 150 could be received at a junction point of the crankcase 110 and the cylinder block 104 or in the cylinder block 104 in some embodiments.

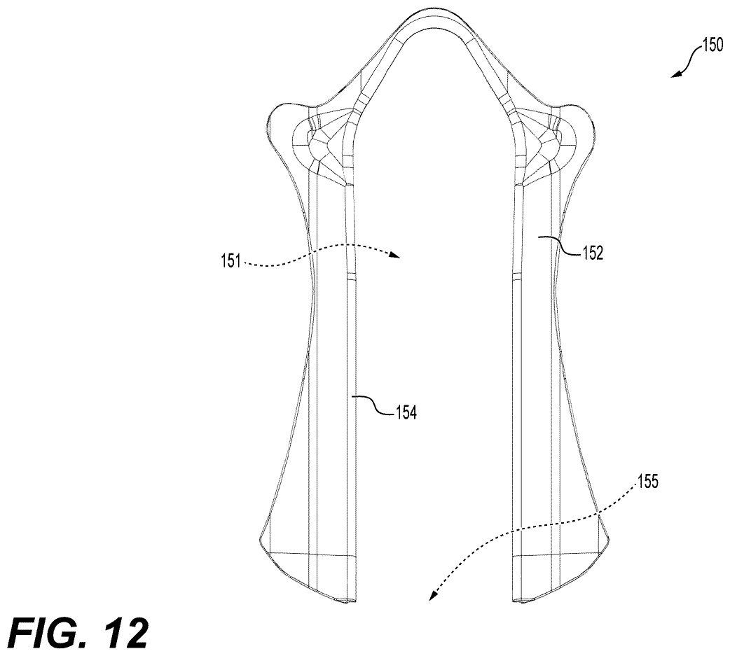

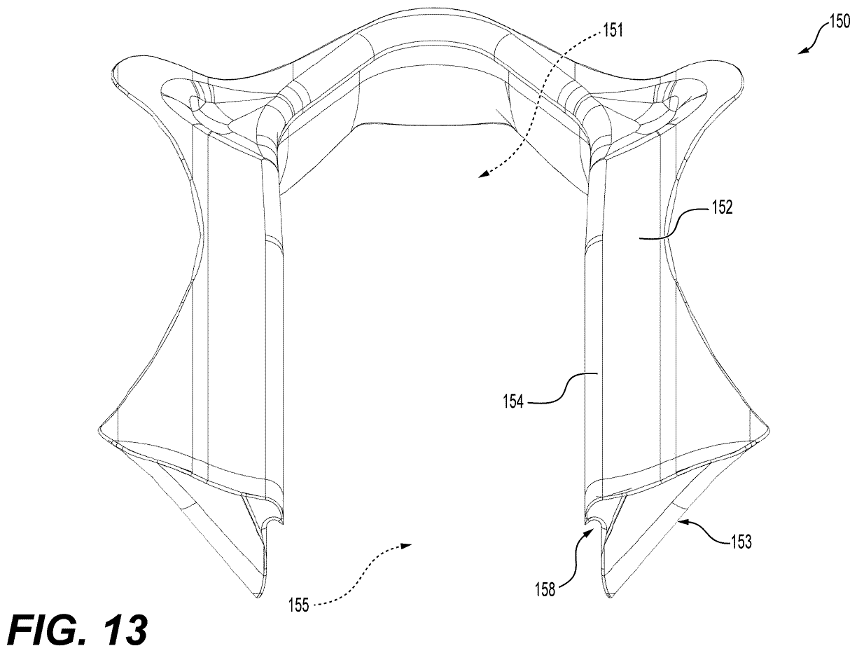

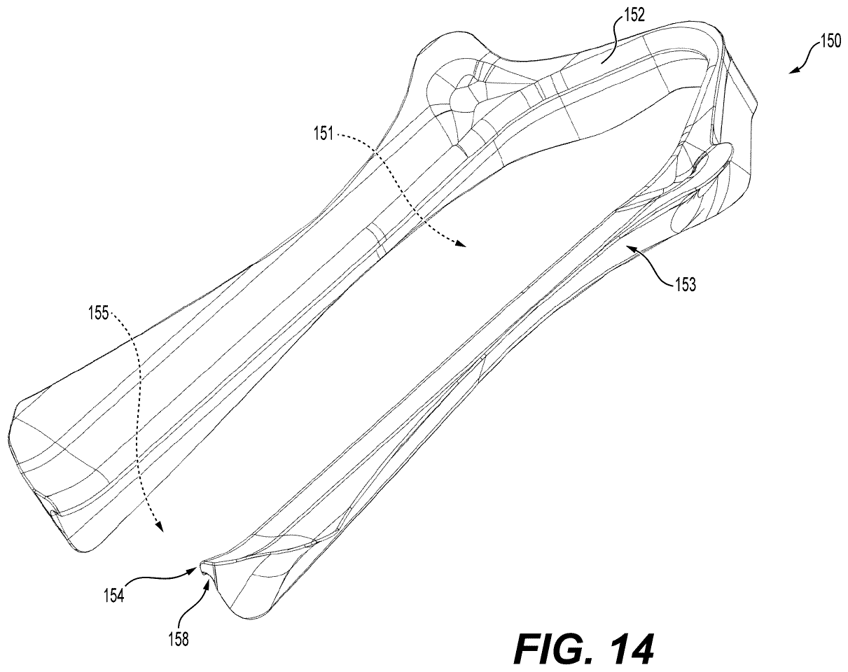

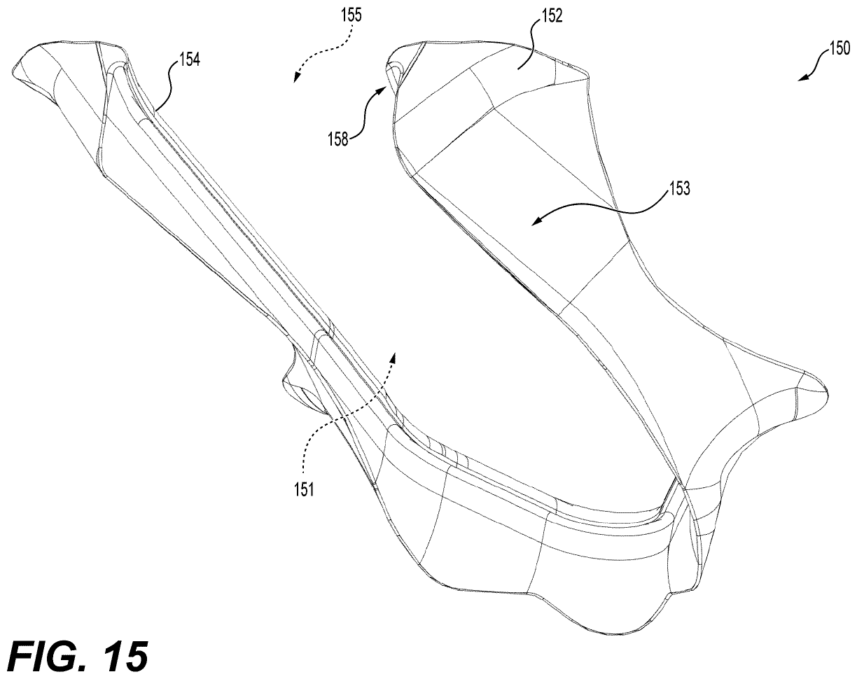

Shown in isolation in FIGS. 12 to 15, the cylinder insert 150 includes a protrusion 154 and a lubrication groove 158 defined in the protrusion 154. A body 152 of the cylinder insert 150, the protrusion 154 being integrally formed with the body 152, is shaped to conform to the walls of the crankcase 130 below each cylinder 102. The body 152 is generally U-shaped, such that an opening 151 is formed to permit free movement of the piston connecting rod 125 therethrough. An outer edge 153 of the cylinder insert 150 is shaped to be in contact with the crankcase 110. An open end 155 of the opening 151 is aligned with the exhaust outlet 127, such that the groove 158 is open to the walls surrounding the cylinder volume 103 on an exhaust side thereof. As installed in the engine 100, the protrusion 154, and thus the groove 158, extend into the cylinder volume 103 between the piston 120 and the crankshaft 130. The groove 158 is formed on an underside of the protrusion 154 (as installed in the engine 100), to capture oil forced upward from the crankshaft 130 toward the cylinder 102 during operation of the engine 100, generally during upstroke of the piston 120.

The lubrication groove 158 is shaped and arranged to collect oil droplets pushed by air or vibration toward the piston 120 during operation of the engine assembly 99. Oil dispersed generally upward along the walls of the crankcase 110 below each cylinder 102 is directed by the body 152 of the insert 150 into the groove 158. The groove 158 is defined in a plane nearly orthogonal relative to an axis of motion of the corresponding piston 120, with a slight angle toward the opening 155 on the exhaust side, such that oil is directed to an exhaust side of the cylinder liner 122. The cylinder insert 150 thus redirects the oil droplets to a location requiring additional lubrication, in this case the exhaust side of the cylinder liner 122. In different embodiments, the cylinder insert 150 and/or the groove 158 could be differently arranged such that the oil is directed to a different location in the engine block 101. By capturing oil along the walls defining the cylinder volume 103 and delivering the oil to a location requiring additional lubrication, lubrication may be improved without the additional oil introduction in the engine 100. It is further noted that capturing oil that may otherwise be combusted may improve emissions of the engine 100.

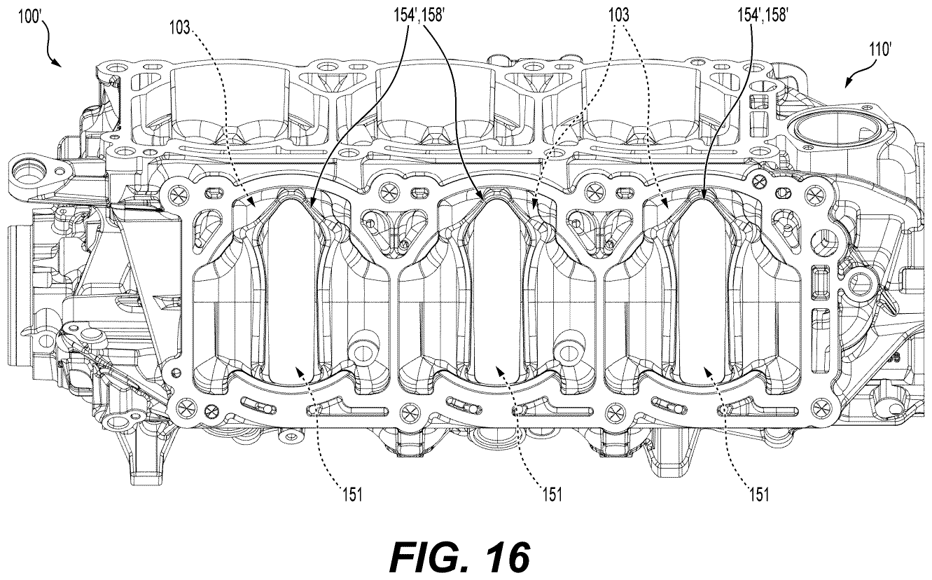

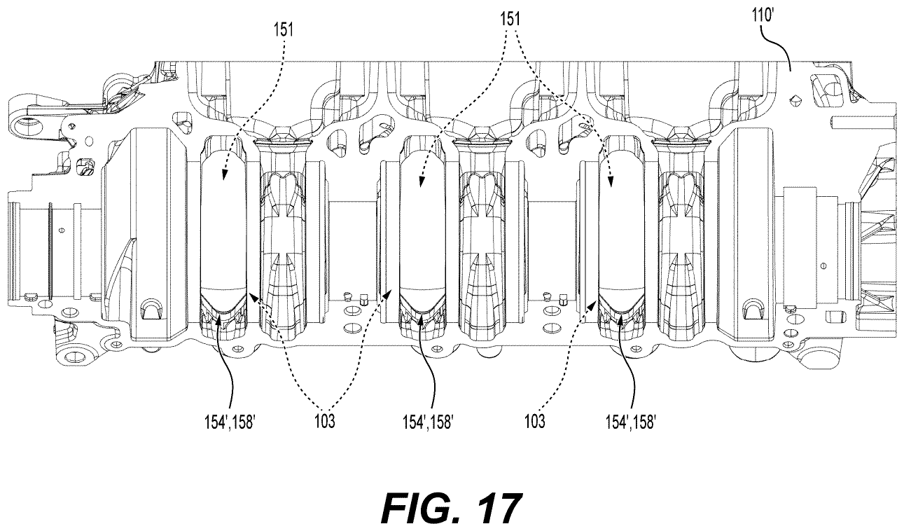

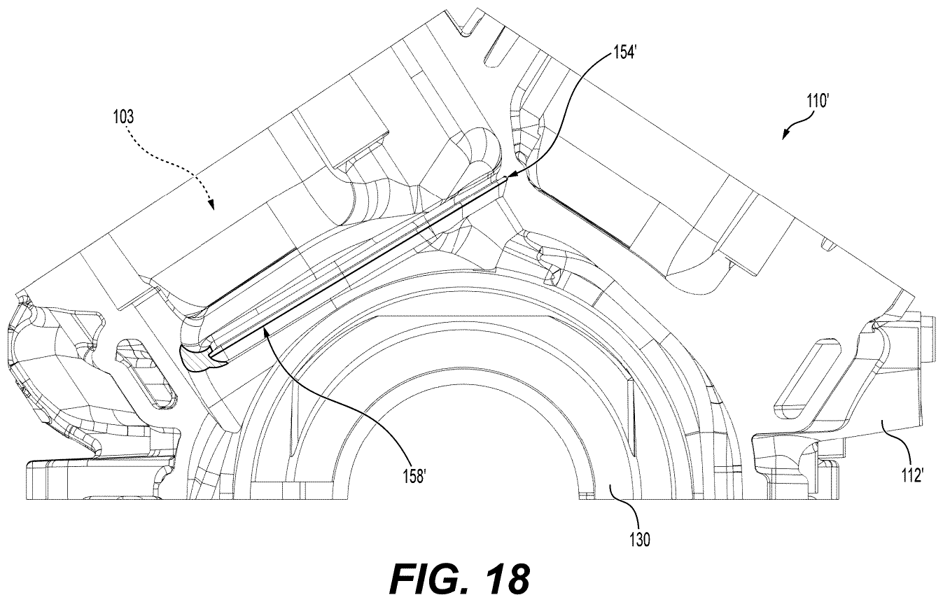

With reference to FIGS. 16 to 18, another non-limiting embodiment of an engine 100′ is described, in reference to an illustrated crankcase 110′. Elements of the engine 100′ that are similar to those of the engine 100 retain the same reference numeral and will generally not be described again. The crankcase 110′, specifically an upper crankcase 112′, includes a protrusion 154′ and a groove′ 158 integrally formed by the crankcase 110′. The protrusion 154′ extends into the cylinder volume 103 defined in the engine 100′. The groove 158′ is defined in an underside of the protrusion 154′, such that oil droplets pushed toward the cylinder 120 along walls defining the cylinder volume 103 are collected and directed toward the exhaust side of the cylinder liner 122, similarly to the groove 158 defined by the cylinder insert 150.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A two-stroke engine assembly comprising:
an engine comprising:
an engine block;
at least one cylinder formed by the engine block, a cylinder volume being defined by the at least one cylinder;
a crankshaft disposed in the engine block;
at least one piston disposed in the at least one cylinder; and
a protrusion extending into the cylinder volume, the protrusion defining a lubrication groove therein, the lubrication groove being disposed between the crankshaft and the at least one piston; and
a lubrication system providing oil to the engine,
the lubrication groove being shaped and arranged to collect oil droplets pushed by air toward the at least one piston during operation and to redirect the oil droplets to at least one pre-determined location in the at least one cylinder.

2. The engine assembly of claim 1, wherein the engine block comprises:
a crankcase, and
at least one cylinder block connected to the crankcase.

3. The engine assembly of claim 1, wherein the protrusion is integrally connected to and formed by the engine block, the protrusion being formed by a cylinder wall defining the at least one cylinder.

4. The engine assembly of claim 1, further comprising at least one cylinder insert disposed in the at least one cylinder; and
wherein the at least one cylinder insert includes the protrusion and the lubrication groove defined in the protrusion.

5. The engine assembly of claim 4, wherein the at least one cylinder insert is formed from a hardened plastic.

6. The engine assembly of claim 1, wherein:
the lubrication groove is continuous about a portion of the at least one cylinder; and
the lubrication groove is open to the at least one cylinder at the at least one pre-determined location.

7. The engine assembly of claim 6, wherein the at least one pre-determined location is an exhaust side of the at least one cylinder.

8. The engine assembly of claim 1, further comprising:
at least one cylinder liner disposed in the at least one cylinder; and
wherein the lubrication groove is shaped and arranged to direct oil droplets toward at least one portion of the at least one cylinder liner.

9. The engine assembly of claim 8, wherein the lubrication groove is shaped and arranged to direct oil droplets toward an exhaust side of the at least one cylinder liner.

10. The engine assembly of claim 9, wherein the lubrication groove is sloped at an angle relative to the exhaust side of the at least one cylinder liner.
